(19) United States
(12) Patent Application Publication
(10) Pub. No.: US 2025/0247939 A1
(43) Pub. Date: Jul. 31, 2025

(54) X-RAY GENERATOR

(71) Applicant: HAMAMATSU PHOTONICS K.K., Hamamatsu-shi (JP)

(72) Inventors: Atsushi ISHII, Hamamatsu-shi (JP); Tatsuya Matsumura, Hamamatsu-shi (JP); Naonobu Suzuki, Hamamatsu-shi (JP); Dai Haraguchi, Hamamatsu-shi (JP)

(73) Assignee: HAMAMATSU PHOTONICS K.K., Hamamatsu-shi (JP)

(21) Appl. No.: 18/966,423

(22) Filed: Dec. 3, 2024

(30) Foreign Application Priority Data
Jan. 31, 2024 (JP) 2024-012806

(51) Int. Cl. H05G 1/10; H05G 1/04

(52) U.S. Cl. CPC H05G 1/10; H05G 1/04

(57) ABSTRACT

An X-ray generator includes: a housing; an electron gun; a target; a source; a feeder; and a fixing member including at least one of a first fixing member that is insulating and a second fixing member that is insulating or conductive, in which the source includes: an insulator that is solid; and a circuit, the circuit includes: a first voltage section; a booster configured to boost a first voltage to a second voltage; and a second voltage section configured to output the second voltage to the electron gun or the target through the feeder, the first fixing member is embedded in the insulator, is fixed to the circuit, and reaches a surface of the insulator, and the second fixing member is embedded in the insulator, and is fixed to each of the circuit and the feeder.

### TECHNICAL FIELD

The present disclosure relates to an X-ray generator.

### BACKGROUND

As an X-ray generator, known is an X-ray generator including a housing, an electron gun that emits an electron beam into the housing, a target that generates an X-ray beam in response to incidence of the electron beam on the target in the housing; a source that generates a voltage to be applied to the electron gun or the target, and a feeder that feeds the voltage to the electron gun or the target, in which the source includes an insulator and a circuit covered with the insulator (see, for example, Japanese Unexamined Patent Publication No. 2004-213974).

### SUMMARY

In such an X-ray generator as described above, because the circuit is covered with the insulator, discharging within the source is prevented. In such an X-ray generator, in a case where the circuit is positionally displaced in the insulator in use of the X-ray generator or at the time of manufacturing thereof, discharging may occur within the source.

An object of the present disclosure is to provide an X-ray generator that can prevent the positional displacement of a circuit in an insulator.

An X-ray generator according to one aspect of the present disclosure includes: a housing; an electron gun configured to emit an electron beam inside the housing; a target configured to generate an X-ray beam in response to incidence of the electron beam on the target inside the housing; a source configured to generate a voltage to be applied to the electron gun or the target; a feeder configured to feed the voltage to the electron gun or the target; and a fixing member including at least one of a first fixing member that is insulating or a second fixing member that is insulating and conductive, in which the source includes: an insulator that is solid; and a circuit embedded in the insulator, the circuit includes: a first voltage section configured to receive a first voltage from outside; a booster configured to boost the first voltage to a second voltage as the voltage; and a second voltage section configured to output the second voltage to the electron gun or the target through the feeder, the first fixing member is embedded in the insulator, is fixed to the circuit, and reaches a surface of the insulator, and the second fixing member is embedded in the insulator, and is fixed to each of the circuit and the feeder.

An X-ray generator according to one aspect of the present disclosure includes: a housing; an electron gun configured to emit an electron beam inside the housing; a target configured to generate an X-ray beam in response to incidence of the electron beam on the target inside the housing; a source configured to generate a voltage to be applied to the electron gun or the target; a feeder configured to feed the voltage to the electron gun or the target; and a fixing member including at least one of a first fixing member that is insulating and a second fixing member that is insulating or conductive, wherein the source includes: a container; an insulator that is liquid or gaseous, the insulator being stored in the container; and a circuit being covered with the insulator, the circuit includes: a first voltage section configured to receive a first voltage from outside; a booster configured to boost the first voltage to a second voltage as the voltage; and a second voltage section configured to output the second voltage to the electron gun or the target through the feeder, the first fixing member is covered with the insulator, and is fixed to each of the circuit and the container, and the second fixing member is covered with the insulator, and is fixed to each of the circuit and the feeder.

### BRIEF DESCRIPTION OF THE DRAWINGS

FIG. 1 is a sectional view of an X-ray generator according to a first embodiment;

FIG. 2 is a partially perspective view of the X-ray generator in FIG. 1;

FIG. 3 is a sectional view of an X-ray generator according to a second embodiment;

FIG. 4 is a partially sectional view of the X-ray generator in FIG. 3;

FIG. 5 is a sectional view of an X-ray generator according to a third embodiment; and

FIG. 6 is a sectional view of an X-ray generator according to a modification.

### DETAILED DESCRIPTION

Hereinafter, embodiments of the present disclosure will be described in detail with reference to the accompanying drawings. In the drawings, the same or corresponding parts are denoted by the same reference signs, and redundant description will not be given.

### [X-Ray Generator of First Embodiment]

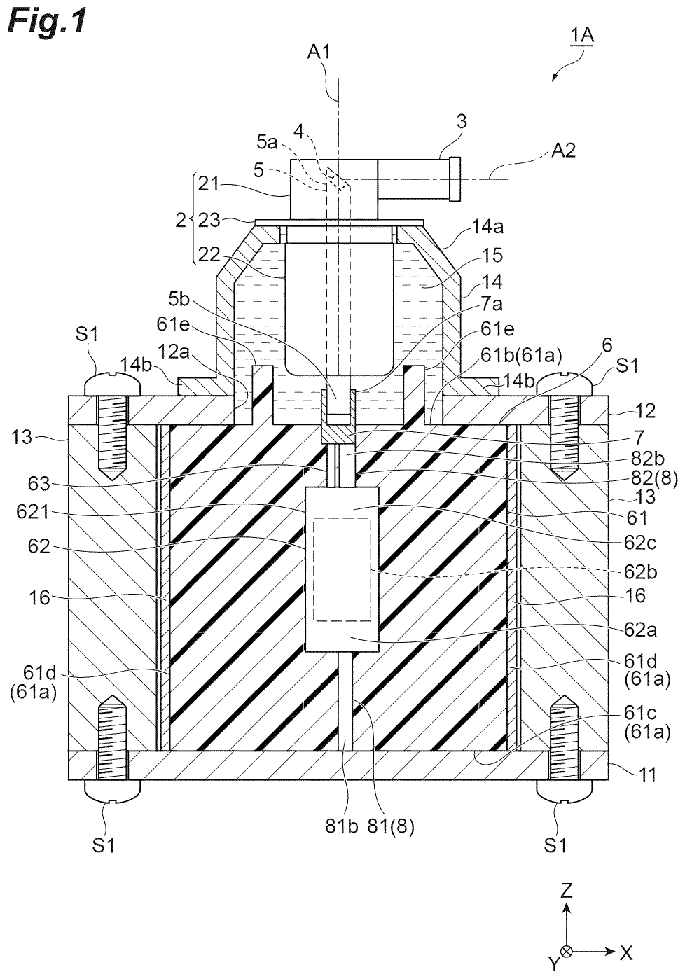

As illustrated in FIG. 1, an X-ray generator 1A of a first embodiment includes a housing 2, an electron gun 3, a target 4, an anode 5, a source 6, a feeder 7, and a fixing member 8. The X-ray generator 1A is, for example, a microfocus X-ray source to be used for X-ray non-destructive inspection.

The housing 2 houses the electron gun 3, the target 4, and the anode 5. The space within the housing 2 is a space to be evacuated. The housing 2 includes a head 21, a valve 22, and a flange 23. The head 21 made of a metal material such as stainless steel has a bottomed cylindrical shape. The valve 22 made of an insulating material such as glass has a bottomed cylindrical shape. The head 21 is airtightly joined to the valve 22 such that the inside of the head 21 is in communication with the inside of the valve 22. The flange 23 made of a metal material such as stainless steel has an annular shape along the outer edge of the head 21. Here, a direction along the central axis (pipe axis) A1 of the valve 22 is referred to as a Z-axis direction (second direction), a direction perpendicular to the Z-axis direction is referred to as an X-axis direction (first direction), and a direction perpendicular to both the Z-axis direction and the X-axis direction is referred to as a Y-axis direction.

The electron gun 3 emits an electron beam to the target 4 inside the housing 2. The electron gun 3 includes a hot cathode that emits thermoelectrons, an extraction electrode that extracts electrons, an electron lens that adjusts convergence of an electron beam (all not illustrated), for example. The electron gun 3 may include a cold cathode instead of the hot cathode. The electron gun 3 is fixed to the head 21 such that the central axis A2 of the electron gun 3 is orthogonal to the central axis A1 of the valve 22. The central axis A2 of the electron gun 3 is along the X-axis direction.

The target 4 generates an X-ray beam inside the housing 2, in response to incidence of the electron beam emitted from the electron gun 3 on the target 4. The target 4 made of a high melting point metal material such as tungsten has a plate shape. The target 4 is supported by the anode 5 inside the housing 2 so as to face the electron gun 3 in the X-axis direction. The target 4 may be integrated with the anode 5.

The anode 5 applies a voltage generated by the source 6 to the target 4. Therefore, the anode 5 is in conduction with the target 4. The anode 5 made of a metal material such as copper extends along the Z-axis direction. The anode 5 extends from the outside of the housing 2 to the inside of the housing 2 such that the central axis of the anode 5 coincides with the central axis A1 of the valve 22. The anode 5 is fixed to the bottom of the valve 22. The anode 5 has a leading end face inside the housing 2, and the leading end face is an inclined face inclined to both the central axis A1 and the central axis A2. The anode 5 has a leading end portion 5a, and the target 4 is embedded in the leading end portion 5a of the anode 5 so as to be flush with the leading end face of the anode 5.

The source 6 generates a voltage to be applied to the target 4 through the feeder 7 and the anode 5. The source 6 is disposed on one side of location in the Z-axis direction with respect to the housing 2 (below the housing 2). The source 6 includes an insulator 61, a circuit 62, and a wiring 63.

The insulator 61 is a solid insulator that electrically insulates each of the circuit 62 and the wiring 63 from other members. The insulator 61 made of a resin material such as epoxy resin has a rectangular parallelepiped shape. The insulator 61 has a surface 61a including an upper face 61b as a face on the side of location of the housing 2, a lower face 61c opposed to the upper face 61b, and a side face 61d connecting the upper face 61b and the lower face 61c to each other. The upper face 61b has a central portion provided with an annular wall 61e.

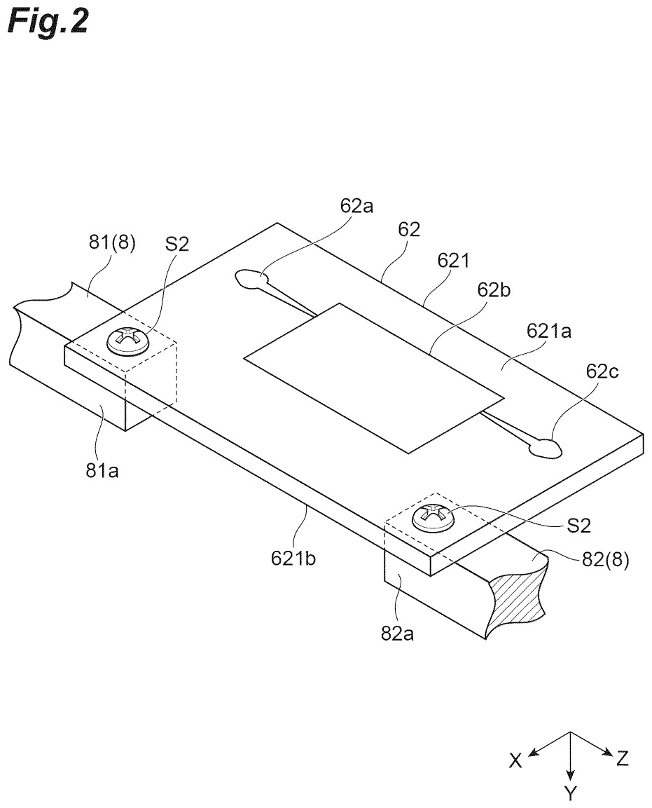

The circuit 62 includes a substrate 621 as a rectangular printed circuit board. The substrate 621 has a front face 621a (see FIG. 2) orthogonal to the Y-axis direction. A first voltage section 62a, a booster 62b, and a second voltage section 62c are mounted on the front face 621a of the substrate 621. The first voltage section 62a includes an input terminal to receive a first voltage from the outside through a power supply section (not illustrated), and is electrically connected to the booster 62b. The booster 62b includes a boosting circuit that boosts the first voltage to a second voltage. The booster 62b is, for example, a Cockcroft-Walton multiplier. The second voltage section 62c includes an output terminal to output the second voltage to be applied to the target 4, and is electrically connected to the booster 62b. The output terminal outputs the second voltage to the target 4 through the wiring 63, the feeder 7, and the anode 5. That is, it can be said that the first voltage section 62a is a low-voltage section of the circuit 62, whereas the second voltage section 62c is a high-voltage section of the circuit 62, and the booster 62b is substantially included in the high-voltage section of the circuit 62. In other words, the substrate 621 includes a relatively low-voltage region where the first voltage section 62a is disposed and a relatively high-voltage region where the booster 62b and the second voltage section 62c are disposed. The surface of the substrate 621 may be orthogonal to either the X-axis direction or the Z-axis direction. Either one of both faces of the substrate 621 may be used as the surface of the substrate 621 (the surface with the first voltage section 62a and others mounted thereon).

The booster 62b is located at a central portion of the front face 621a of the substrate 621. The first voltage section 62a is located on one side of location in the Z-axis direction with respect to the booster 62b (lower face 61c side). The second voltage section 62c is located on the other side of location in the Z-axis direction with respect to the booster 62b (upper face 61b side).

The circuit 62 is embedded in the insulator 61 such that the entirety of the circuit 62 is located within the insulator 61. The circuit 62 is embedded in the insulator 61 such that the substrate 621 extends straight along the Z-axis direction.

The wiring 63 electrically connects the second voltage section 62c and the target 4 through the feeder 7 and the anode 5. The wiring 63 has one end electrically connected to the second voltage section 62c and the other end connected to the feeder 7. In the present embodiment, the wiring 63 is made of, for example, a copper wire and a covering member covering the copper wire, but may be a plate material or a rod material made of a conductive material. The wiring 63 is embedded in the insulator 61 such that at least part of the wiring 63 is located within the insulator 61. In the X-ray generator 1A, the entirety of the wiring 63 is embedded in the insulator 61 such that the part of the wiring 63 is along the Z-axis direction.

The feeder 7 feeds, to the target 4, the second voltage output from the second voltage section 62c. The feeder 7 is a socket that is made of a metal material such as aluminum and has a cylindrical shape. The feeder 7 is embedded in the insulator 61 such that part 7a of the feeder 7 is exposed outward from the insulator 61. The part 7a protrudes outward the insulator 61 from the upper face 61b. The part 7a is surrounded by the wall 61e when viewed in the Z-axis direction. The anode 5 has a base end portion 5b fitted to the part 7a. The feeder 7 is fixed to the housing 2 through the anode 5. That is, the housing 2 and the feeder 7 are mutually fixed.

The target 4, the anode 5, and the feeder 7 overlap the insulator 61 when viewed in the Z-axis direction. The circuit 62 is embedded in the insulator 61 such that the second voltage section 62c is located between the first voltage section 62a and the target 4 in the Z-axis direction.

The fixing member 8 will be described in detail with reference to FIG. 2. The fixing member 8 includes a first fixing member 81 and a second fixing member 82.

The first fixing member 81 is insulating. In the X-ray generator 1A, the first fixing member 81 made of an insulating material has a rod shape and extends along the Z-axis direction. As an example, the first fixing member 81 made of glass epoxy has a rectangular parallelepiped shape and extends along the Z-axis direction. The first fixing member 81 is embedded in the insulator 61 and is fixed to the circuit 62. In the X-ray generator 1A, the first fixing member 81 has an end portion 81a on one side of location in the Z-axis direction and another end portion 81b on the other side of location in the Z-axis direction. The end portion 81a is fixed to the substrate 621. Specifically, the end portion 81a is in contact with a back face 621b of the substrate 621 opposed to the front face 621a thereof, and in this state, the body of a screw S2 is inserted in a through hole (not illustrated) provided to the substrate 621 and is screwed in a screw hole (not illustrated) provided to the end portion 81a. Note that the joining between the first fixing member 81 and the substrate 621 is not limited to such screwing, and thus may be bonding by, for example, adhesive or thermal fusion. The end portion 81b reaches the surface 61a (lower face 61c) of the insulator 61. In the X-ray generator 1A, an end face of the first fixing member 81 included in the end portion 81b is flush with the surface 61a (lower face 61c).

The second fixing member 82 is insulating. In the X-ray generator 1A, the second fixing member 82 made of an insulating material has a rod shape and extends along the Z-axis direction. As an example, the second fixing member 82 made of glass epoxy has a rectangular parallelepiped shape and extends along the Z-axis direction. The second fixing member 82 is embedded in the insulator 61 and is fixed to each of the circuit 62 and the feeder 7. In the X-ray generator 1A, the second fixing member 82 has an end portion 82a on one side of location in the Z-axis direction and another end portion 82b on the other side of location in the Z-axis direction. The end portion 82a is fixed to the substrate 621. Specifically, the end portion 82a is in contact with the back face 621b of the substrate 621, and in this state, the body of a screw S2 is inserted in a through hole (not illustrated) provided to the substrate 621 and is screwed in a screw hole (not illustrated) provided to the end portion 82a. Note that the joining between the second fixing member 82 and the substrate 621 is not limited to such screwing, and thus may be bonding by, for example, adhesive or thermal fusion. The end portion 82b is fixed to part of the feeder 7 embedded in the insulator 61. Specifically, the end portion 82b is screwed to the part of the feeder 7 embedded in the insulator 61. Note that the joining between the second fixing member 82 and the feeder 7 is not limited to such screwing, and thus may be bonding by, for example, adhesive or thermal fusion.

The first fixing member 81 is fixed to the circuit 62 at a position on the side of location of the first voltage section 62a with respect to the booster 62b, namely, in the low-voltage region of the circuit 62. The second fixing member 82 is fixed to the circuit 62 at a position on the side of location of the second voltage section 62c with respect to the booster 62b, namely, in the high-voltage region of the circuit 62. That is, the first fixing member 81 and the second fixing member 82 are fixed to the circuit 62 so as to sandwich the booster 62b in the Z-axis direction. The first fixing member 81 can be referred to as a low-voltage-side fixing member, and the second fixing member 82 can be referred to as a high-voltage-side fixing member.

The X-ray generator 1A further includes a first plate member 11, a second plate member 12, a plurality of pillars 13 (four pillars 13 in the present embodiment), a tubular member 14, an insulating oil 15, and a conductive paint 16. The conductive paint 16 is applied to the side face 61d of the insulator 61, and the potential of the side face 61d is set as the ground potential.

The first plate member 11 made of a metal material such as aluminum has a rectangular plate shape. The insulator 61 is disposed on the first plate member 11 such that the lower face 61c is in contact with the first plate member 11. The second plate member 12 made of a metal material such as aluminum has a rectangular plate shape. The second plate member 12 is disposed on the insulator 61 so as to be in contact with the upper face 61b. The second plate member 12 is provided with an opening 12a. The wall 61e and the feeder 7 are located inside the opening 12a when viewed in the Z-axis direction.

Each of the plurality of pillars 13 is disposed between the corresponding corner of the four corners of the first plate member 11 and the corresponding corner of the four corners of the second plate member 12. Each of the plurality of pillars 13 is made of a metal material such as aluminum and has a rectangular parallelepiped shape. The first plate member 11 and the second plate member 12 are mutually fixed through the pillar 13. Specifically, the body of a screw S1 is inserted through a through hole provided to the first plate member 11 or the second plate member 12 and is screwed into a screw hole provided to the pillar 13. As a result, the first plate member 11 and the second plate member 12 are mutually fixed.

The tubular member 14 stores the insulating oil 15. The tubular member 14 made of a metal material such as aluminum has a cylindrical shape. The tubular member 14 is disposed on the second plate member 12 such that the inside of the tubular member 14 is in communication with the opening 12a. The valve 22 and the anode 5 are located inside the tubular member 14. The tubular member 14 has an end portion 14a in a tapered shape and gradually reduces in diameter toward the leading end face of the tubular member 14. The flange 23 is screwed to the leading end face of the tubular member 14 through a seal member (not illustrated). The tubular member 14 has another end portion provided with a flange 14b. The flange 14b is screwed to the second plate member 12 through a seal member (not illustrated). An internal space is defined by the inner face of the opening 12a, the inner face of the tubular member 14, the flange 23, and the insulator 61. The internal space is filled with the insulating oil 15 containing, for example, mineral oil as a main component. The insulating oil 15 covers the valve 22, part of the anode 5 exposed outward from the housing 2, and part of the feeder 7 exposed outward from the insulator 61.

In the X-ray generator 1A having the configuration as described above, with the side face 61d of the insulator 61 set as the ground potential, for example, several hundreds of voltages (V) as a first voltage are received by the first voltage section 62a through the power supply section from an external source device. The booster 62b boosts the first voltage to a second voltage of several kilovolts (kV) to several hundreds of kilovolts (kV), for example. Then, the second voltage section 62c outputs the second voltage to the target 4 through the wiring 63, the feeder 7, and the anode 5. An X-ray beam is generated from the target 4 in response to incidence of an electron beam on the target 4 from the electron gun 3 with the second voltage applied to the target 4. The X-ray generator 1A is a so-called sealed reflection type X-ray generator. Power supply to the electron gun 3 may be performed by a transformer (not illustrated) included in the source 6 or may be performed by the circuit 62.

The source 6 of the X-ray generator 1A is manufactured as follows, for example. First, the circuit 62, the wiring 63, the feeder 7, the first fixing member 81, and the second fixing member 82 are each disposed at the corresponding predetermined position in a mold. Then, the first fixing member 81 is fixed to both the circuit 62 and the mold. The second fixing member is fixed to both the circuit 62 and the feeder 7, and part 7a of the feeder 7 is fixed to the mold. In this state, a thermosetting resin is introduced into the mold. Then, the thermosetting resin is thermally cured in the mold to form an insulator 61.

### [Functions and Effects]

As described above, in the X-ray generator 1A, the fixing member 8 includes both the first fixing member 81 that is insulating and the second fixing member 82 that is insulating. The first fixing member 81 embedded in the insulator 61 is fixed to the circuit 62 and reaches the surface 61a of the insulator 61. Thus, for example, in molding of the insulator 61 at the time of manufacturing the X-ray generator 1A, the first fixing member 81 is fixed to each of the circuit 62 and the mold, so that the position of the circuit 62 in the insulator 61 can be kept stable. That is, by fixing, to the mold, part of the first fixing member 81 exposed outward from the insulator 61, the position of the circuit 62 in the insulator 61 can be kept stable through the first fixing member 81. Thus, the positional displacement of the circuit 62 in the insulator 61 can be reliably prevented. In addition, because the first fixing member 81 is insulating, even if the first fixing member 81 is exposed outward from the insulator 61, external discharging from the circuit 62 through the first fixing member 81 can be prevented. Further, the second fixing member 82 embedded in the insulator 61 is fixed to each of the circuit 62 and the feeder 7. Thus, for example, in molding of the insulator 61 at the time of manufacturing the X-ray generator 1A, the position of the circuit 62 in the insulator 61 can be kept stable. Therefore, according to the X-ray generator 1A, the positional displacement of the circuit 62 in the insulator 61 can be prevented.

In the X-ray generator 1A, the fixing member 8 includes the second fixing member 82, and the feeder 7 is embedded in the insulator 61 such that the part 7a of the feeder 7 is exposed outward from the insulator 61. With this arrangement, for example, in molding of the insulator 61 at the time of manufacturing the X-ray generator 1A, by fixing, to the mold, the part 7a of the feeder 7 exposed outward from the insulator 61, the position of the circuit 62 in the insulator 61 can be kept stable through the feeder 7 and the second fixing member 82. Thus, the positional displacement of the circuit 62 in the insulator 61 can be reliably prevented.

In the X-ray generator 1A, the fixing member 8 includes both the first fixing member 81 and the second fixing member 82. With this arrangement, the position of the circuit 62 in the insulator 61 can be reliably fixed by both the first fixing member 81 and the second fixing member 82.

In the X-ray generator 1A, the circuit 62 includes the substrate 621 with the first voltage section 62a, the booster 62b, and the second voltage section 62c mounted thereon, and the first fixing member 81 and the second fixing member 82 are both fixed to the substrate 621. With this arrangement, the first fixing member 81 and the second fixing member 82 can be fixed to the circuit 62 so as not to physically interfere with the first voltage section 62a, the booster 62b, and the second voltage section 62c.

In the X-ray generator 1A, the first fixing member 81 is fixed to the side of location of the first voltage section 62a of the circuit 62 with respect to the booster 62b, and the second fixing member 82 is fixed to the side of location of the second voltage section 62c of the circuit 62 with respect to the booster 62b. With this arrangement, the first fixing member 81 and the second fixing member 82 can be fixed to the circuit 62 such that the first fixing member 81 and the second fixing member 82 do not affect the booster 62b.

### [X-Ray Generator of Second Embodiment]

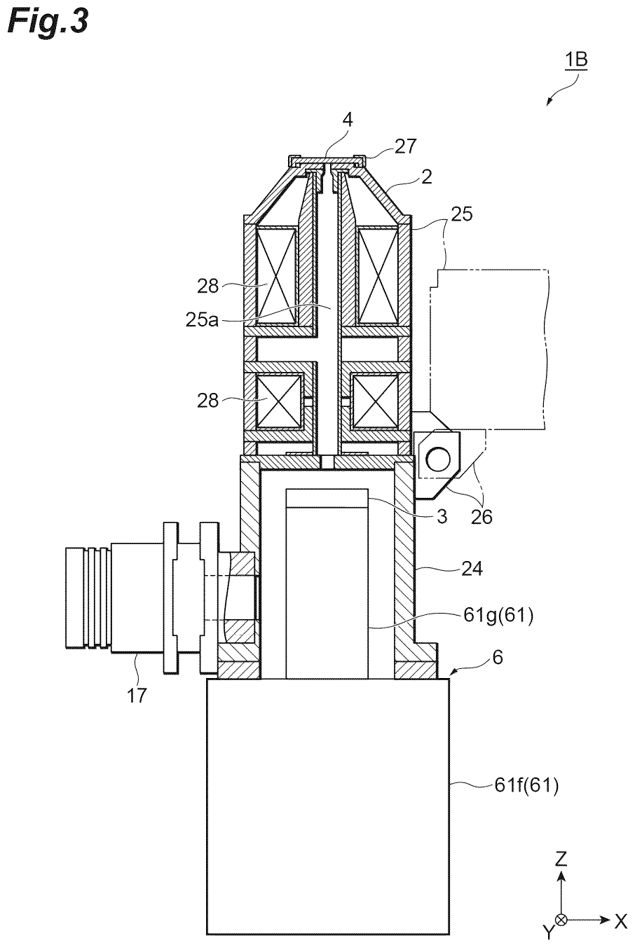

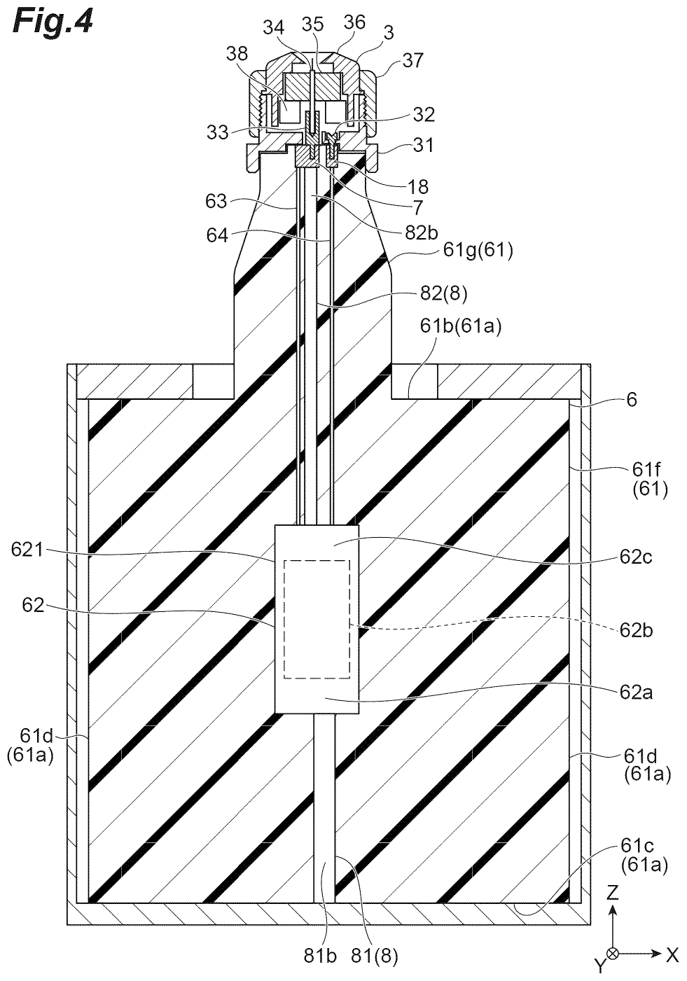

As illustrated in FIGS. 3 and 4, an X-ray generator 1B of a second embodiment is mainly different from the X-ray generator 1A of the first embodiment in that the inside of a housing 2 is configured to open and close and that a circuit 62 outputs a second voltage to an electron gun 3. Hereinafter, the X-ray generator 1B of the second embodiment will be described focusing on such differences from the X-ray generator 1A of the first embodiment.

The X-ray generator 1B further includes an exhaust pipe 17 and a feeder 18. A source 6 further includes a wiring 64 and an electron emission controller (not illustrated) electrically connected to a wiring 63 and the wiring 64.

The housing 2 includes a fixing part 24, a detachable part 25, a hinge 26, and a cap 27. Each of the fixing part 24 and the detachable part 25 is made of a metal material such as stainless steel and has a cylindrical shape. The detachable part 25 is attached to the fixing part 24 through the hinge 26. The detachable part 25 defines a passage 25a through which an electron beam passes. The fixing part 24 has a side wall with the exhaust pipe 17 attached thereto. A vacuum pump (not illustrated) is connected to the exhaust pipe 17. The detachable part 25 has an upper end with a target 4 attached thereto and the target 4 is accommodated in the cap 27. In the X-ray generator 1B, the detachable part 25 is tilted to the fixing part 24 to open the inside of the housing 2, so that, for example, a filament of the electron gun 3 can be replaced. A plurality of coils 28 is provided inside the detachable part 25. The plurality of coils 28 functions as an electromagnetic deflection lens, and focus, on the target 4, an electron beam traveling through the passage 25a from the electron gun 3 to the target 4.

An insulator 61 includes a first portion 61f having a rectangular parallelepiped shape and a second portion 61g having a columnar shape provided on the first portion 61f. The first portion 61f has an upper end with the fixing part 24 attached thereto. The second portion 61g is located inside the fixing part 24. Part of each of a feeder 7 and the feeder 18 is embedded in the second portion 61g.

The second portion 61g has a leading end with the electron gun 3 attached thereto. The electron gun 3 includes a grid base 31, a screw 32, a heater socket 33, a heater pin (filament) 34, a heater base 35, a grid cap 36, a ring 37, and a ring 38. The grid base 31 is fixed to the feeder 18 with the screw 32. The heater socket 33 is fitted to the feeder 7. The heater pin 34 is detachably attached to the heater socket 33. The heater base 35 supports the heater pin 34. The heater pin 34 and the heater base 35 constitute a cathode electrode. The grid cap 36 covers the heater pin 34 and the heater base 35. The ring 37 is screwed in the grid base 31 and presses the grid cap 36. With this arrangement, the position of the heater base 35 in the grid cap 36 is fixed in cooperation with the ring 38.

The wiring 63 electrically connects a second voltage section 62c and the electron gun 3 (heater socket 33) through the feeder 7. The wiring 63 has one end electrically connected to the second voltage section 62c and the other end connected to the feeder 7. The wiring 64 electrically connects the second voltage section 62c and the electron gun 3 (screw 32) through the feeder 18. The wiring 64 has one end electrically connected to the second voltage section 62c and the other end connected to the feeder 18. The wiring 63 is embedded in the insulator 61 such that the entirety of the wiring 63 is located within the insulator 61. The wiring 64 is embedded in the insulator 61 such that the entirety of the wiring 64 is located within the insulator 61.

In the X-ray generator 1B having the configuration as described above, with the target 4 set as the ground potential, for example, several hundreds of voltages (V) as a first voltage are received by a first voltage section 62a through a power supply section from an external source device. A booster 62b boosts the first voltage to a second voltage of several kilovolts (kV) to several hundreds of kilovolts (kV), for example. Then, the second voltage section 62c outputs the second voltage to the electron gun 3 through the wiring 63 and the feeder 7. Due to heating of the heater pin 34 through the heater socket 33, an electron beam from the heater pin 34 is emitted. An X-ray beam is generated from the target 4 in response to incidence of the electron beam on the target 4 from the electron gun 3. The X-ray generator 1B is a so-called open transmission type X-ray generator.

As described above, in the X-ray generator 1B, the inside of the housing 2 is configured to open and close. With this arrangement, for example, the filament of the electron gun 3 can be replaced.

### [X-Ray Generator of Third Embodiment]

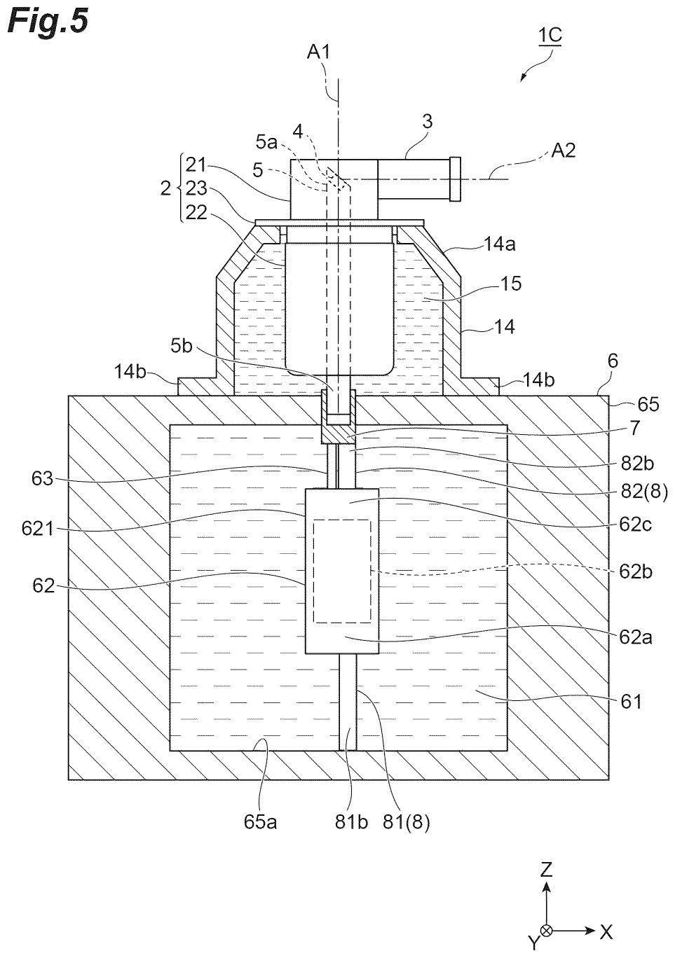

As illustrated in FIG. 5, an X-ray generator 1C of a third embodiment is mainly different from the X-ray generator 1A of the first embodiment in that a source 6 includes a container 65 and an insulator 61 that is liquid stored in the container 65. Hereinafter, the X-ray generator 1C of the third embodiment will be described focusing on such differences from the X-ray generator 1A of the first embodiment.

The source 6 includes the insulator 61, a circuit 62, a wiring 63, and the container 65. The container 65 made of a metal material such as aluminum has a box shape. The insulator 61 is stored inside the container 65. The insulator 61 is a liquid insulator. In the X-ray generator 1C, the insulator 61 is an insulating oil containing, for example, mineral oil as a main component. In the source 6, the circuit 62 and the wiring 63 are covered with the insulator 61 in the container 65.

A feeder 7 is fixed to the container 65 such that part of the feeder 7 is located in the container 65. The feeder 7 is fixed to the container 65 by, for example, screwing with a screw. The part of the feeder 7 is covered with the insulator 61 in the container 65.

A first fixing member 81 is covered with the insulator 61 in the container 65, and is fixed to each of the circuit 62 and the container 65. The first fixing member 81 has an end portion 81a fixed to a substrate 621. Specifically, the end portion 81a is screwed to the substrate 621. Note that the joining between the first fixing member 81 and the substrate 621 is not limited to such screwing, and thus may be bonding by, for example, adhesive or thermal fusion. The first fixing member 81 has an end portion 81b fixed to an inner face 65a of the container 65. Specifically, the end portion 81b is screwed to the inner face 65a of the container 65. Note that the joining between the first fixing member 81 and the inner face 65a of the container 65 is not limited to such screwing, and thus may be bonding by, for example, adhesive or thermal fusion.

A second fixing member 82 is covered with the insulator 61 in the container 65, and is fixed to each of the circuit 62 and the feeder 7. The second fixing member 82 has an end portion 82a fixed to the substrate 621. Specifically, the end portion 82a is screwed to the substrate 621. Note that the joining between the second fixing member 82 and the substrate 621 is not limited to such screwing, and thus may be bonding by, for example, adhesive or thermal fusion. The second fixing member 82 has an end portion 82b fixed to the part of the feeder 7 covered with the insulator 61. Specifically, the end portion 82b is screwed to the part of the feeder 7 covered with the insulator 61. Note that the joining between the second fixing member 82 and the feeder 7 is not limited to such screwing, and thus may be bonding by, for example, adhesive or thermal fusion.

A tubular member 14 includes a flange 14b screwed to an upper face of the container 65 through a seal member (not illustrated). Note that in the present embodiment, an insulating oil 15 and the insulating oil serving as the insulator 61 are partitioned by the container 65, but a penetrating portion may be provided to the partition of the container 65 to allow the insulating oil 15 and the insulating oil serving as the insulator 61 to communicate with each other.

As described above, in the X-ray generator 1C, a fixing member 8 includes both the first fixing member 81 that is insulating and the second fixing member 82 that is insulating. The first fixing member 81 covered with the insulator 61 is fixed to each of the circuit 62 and container 65. Thus, for example, in use of the X-ray generator 1C, the position of the circuit 62 in the insulator 61 can be kept stable. In addition, the second fixing member 82 covered with the insulator 61 is fixed to each of the circuit 62 and the feeder 7. Thus, for example, in use of the X-ray generator 1C the position of the circuit 62 in the insulator 61 can be kept stable. Therefore, according to the X-ray generator 1C, the positional displacement of the circuit 62 in the insulator 61 can be prevented.

In the X-ray generator 1C, the feeder 7 is fixed to the container 65. With this arrangement, for example, in use of the X-ray generator 1C, the position of the circuit 62 in the insulator 61 can be kept stable through the feeder 7 and the second fixing member 82. Thus, the positional displacement of the circuit 62 in the insulator 61 can be reliably prevented.

### Modifications

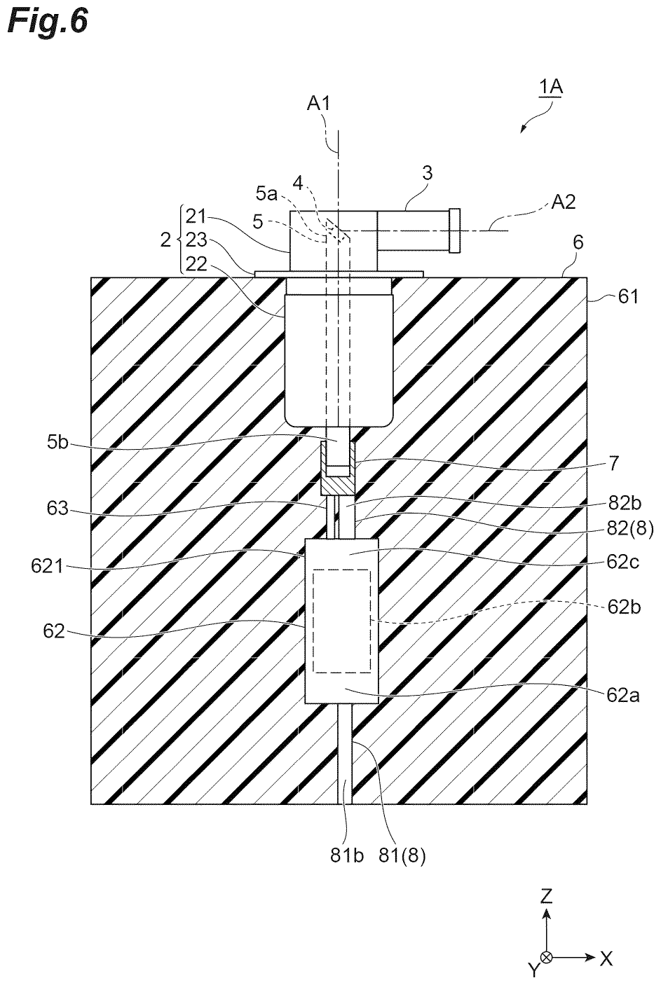

The present disclosure is not limited to the above embodiments. In the X-ray generator 1A of the first embodiment, the circuit 62, the wiring 63, the feeder 7, the first fixing member 81, and the second fixing member 82 are embedded in the insulator 61, but the aspect of the insulator 61 is not limited thereto. For example, as illustrated in FIG. 6, in an X-ray generator 1A, a feeder 7 may be embedded in an insulator 61 such that the entirety of the feeder 7 is located within the insulator 61. An anode 5 may be embedded in the insulator 61 such that part of the anode 5 located outside a housing 2 is located within the insulator 61. The housing 2 may be embedded in the insulator 61 such that part (a head 21 and a flange 23) of the housing 2 is exposed outward from the insulator 61. In this case, for example, in molding of the insulator 61 at the time of manufacturing the X-ray generator 1A, the part of the housing 2 exposed outward from the insulator 61 is fixed to the mold, so that the position of a circuit 62 in the insulator 61 can be kept stable through the housing 2, the feeder 7, and a second fixing member 82. Thus, the positional displacement of the circuit 62 in the insulator 61 can be reliably prevented.

Each of the X-ray generator 1A of the first embodiment, the X-ray generator 1B of the second embodiment, and the X-ray generator 1C of the third embodiment includes both the first fixing member 81 and the second fixing member 82. However, each of the X-ray generators 1A, 1B, and 1C may include at least one of the first fixing member 81 and the second fixing member 82. Even in this case, the positional displacement of the circuit 62 in the insulator 61 can be prevented. In addition, each of the X-ray generator 1A of the first embodiment, the X-ray generator 1B of the second embodiment, and the X-ray generator 1C of the third embodiment includes the second fixing member 82 that is insulating, but may include a second fixing member 82 that is conductive. In this case, the second fixing member 82 can also be used as a feeding path from the circuit 62 to the feeder 7.

In the X-ray generator 1A of the first embodiment, the feeder 7 is embedded in the insulator 61 such that the part 7a of the feeder 7 is located outside the insulator 61. However, in the X-ray generator 1A, the feeder 7 is not necessarily embedded in the insulator 61. For example, the feeder 7 may be fixed on the upper face 61b of the insulator 61. Even in this case, in molding of the insulator 61 at the time of manufacturing the X-ray generator 1A, the feeder 7 located outside the insulator 61 can be fixed to the mold. Similarly, in the X-ray generator 1C, the feeder 7 may be fixed to the container 65, and part of the feeder 7 is not necessarily located in the container 65.

In the X-ray generator 1C of the third embodiment, the insulator 61 is a liquid insulator. However, in the X-ray generator 1C, the insulator 61 may be a gaseous insulator containing, for example, sulfur hexafluoride as a main component.

In the X-ray generator 1A of the first embodiment, the X-ray generator 1B of the second embodiment, and the X-ray generator 1C of the third embodiment, both the first fixing member 81 and the second fixing member 82 are fixed to the back face 621b of the substrate 621. However, each of the first fixing member 81 and the second fixing member 82 may be fixed to the front face 621a of the substrate 621 or may be fixed to a side face of the substrate 621.

In the X-ray generator 1C of the third embodiment, the circuit 62, the wiring 63, the feeder 7, the first fixing member 81, and the second fixing member 82 are covered with the insulator 61. However, the aspect of the insulator 61 is not limited thereto. For example, in the X-ray generator 1C, the feeder 7 may be covered with the insulator 61 such that the entirety of the feeder 7 is located within the insulator 61 (container 65). The anode 5 may be covered with the insulator 61 such that the part of the anode 5 located outside the housing 2 is located within the insulator 61 (container 65). The housing 2 may be covered with the insulator 61 such that the part of the housing 2 (the head 21 and the flange 23) is exposed outward from the container 65. The housing 2 may be fixed to the container 65. That is, the container 65 may store the entirety of the feeder 7 and part of the housing 2 (e.g., the valve 22) with the housing 2 fixed to the container 65. In this case, for example, in use of the X-ray generator 1C, the position of the circuit 62 in the insulator 61 can be kept stable through the housing 2, the feeder 7, and the second fixing member 82. Thus, the positional displacement of the circuit 62 in the insulator 61 can be reliably prevented.

The X-ray generator 1A of the first embodiment and the X-ray generator 1C of the third embodiment are sealed reflection type X-ray generators. However, each of the X-ray generators 1A and 1C may be a sealed transmission type X-ray generator. The X-ray generator 1B of the second embodiment is an open transmission type X-ray generator. However, the X-ray generator 1B may be an open reflection type X-ray generator.

An X-ray generator according to one aspect of the present disclosure is [1] “an X-ray generator including: a housing; an electron gun configured to emit an electron beam inside the housing; a target configured to generate an X-ray beam in response to incidence of the electron beam on the target inside the housing; a source configured to generate a voltage to be applied to the electron gun or the target; a feeder configured to feed the voltage to the electron gun or the target; and a fixing member including at least one of a first fixing member that is insulating and a second fixing member that is insulating or conductive, in which the source includes: an insulator that is solid; and a circuit embedded in the insulator, the circuit includes: a first voltage section configured to receive a first voltage from outside; a booster configured to boost the first voltage to a second voltage as the voltage; and a second voltage section configured to output the second voltage to the electron gun or the target through the feeder, the first fixing member is embedded in the insulator, is fixed to the circuit, and reaches a surface of the insulator, and the second fixing member is embedded in the insulator, and is fixed to each of the circuit and the feeder”.

In the X-ray generator described in [1], the fixing member includes at least one of the first fixing member that is insulating and the second fixing member that is insulating or conductive. In a case where the fixing member includes at least the first fixing member, the first fixing member is embedded in the insulator. The first fixing member is fixed to the circuit and reaches the surface of the insulator. Thus, for example, in molding of the insulator at the time of manufacturing the X-ray generator, the first fixing member is fixed to both the circuit and the mold, so that the position of the circuit in the insulator can be kept stable. In addition, in a case where the fixing member includes at least the second fixing member, the second fixing member is embedded in the insulator and is fixed to each of the circuit and the feeder. Thus, for example, in molding of the insulator at the time of manufacturing the X-ray generator, the position of the circuit in the insulator can be kept stable. Therefore, according to the X-ray generator described in [1], the positional displacement of the circuit in the insulator can be prevented.

An X-ray generator according to one aspect of the present disclosure may be [2] “the X-ray generator according to [1] described above, in which the fixing member includes at least the first fixing member”. According to the X-ray generator described in [2], in molding of the insulator at the time of manufacturing the X-ray generator, part of the first fixing member exposed outward from the insulator is fixed to the mold, so that the position of the circuit in the insulator can be kept stable through the first fixing member. Thus, the positional displacement of the circuit in the insulator can be reliably prevented. Further, because the first fixing member is insulating, even if the first fixing member is exposed outward from the insulator, external discharging from the circuit through the first fixing member can be prevented.

An X-ray generator according to one aspect of the present disclosure may be [3] “the X-ray generator according to [2] described above, in which the fixing member includes both the first fixing member and the second fixing member”. According to the X-ray generator described in [3], the position of the circuit in the insulator can be more reliably fixed by both the first fixing member and the second fixing member.

An X-ray generator according to one aspect of the present disclosure may be [4] “the X-ray generator according to [3] described above, in which the feeder is embedded in the insulator such that part of the feeder is exposed outward from the insulator”. According to the X-ray generator described in [4], for example, in molding of the insulator at the time of manufacturing the X-ray generator, the part of the feeder exposed outward from the insulator is fixed to the mold, so that the position of the circuit in the insulator can be kept stable through the feeder and the second fixing member. Thus, the positional displacement of the circuit in the insulator can be reliably prevented.

An X-ray generator according to one aspect of the present disclosure may be [5] “the X-ray generator according to [3] described above, in which the housing and the feeder are fixed to each other, the feeder is embedded in the insulator such that entirety of the feeder is located within the insulator, and the housing is embedded in the insulator such that part of the housing is exposed outward from the insulator”. According to the X-ray generator described in [5], for example, in molding of the insulator at the time of manufacturing the X-ray generator, the part of the housing exposed outward from the insulator is fixed to the mold, so that the position of the circuit in the insulator can be kept stable through the housing, the feeder, and the second fixing member. Thus, the positional displacement of the circuit in the insulator can be reliably prevented.

An X-ray generator according to one aspect of the present disclosure may be [6] “the X-ray generator according to any one of [1] to [5] described above, in which the circuit further includes a substrate on which the first voltage section, the booster, and the second voltage section are mounted, and at least one of the first fixing member and the second fixing member is fixed to the substrate”. According to the X-ray generator described in [6], at least one of the first fixing member and the second fixing member can be fixed to the circuit so as not to physically interfere with the first voltage section, the booster, and the second voltage section.

An X-ray generator according to one aspect of the present disclosure may be [7] “the X-ray generator according to any one of [1] to [6] described above, in which the first fixing member is fixed to a side of location of the first voltage section of the circuit with respect to the booster, and the second fixing member is fixed to a side of location of the second voltage section of the circuit with respect to the booster”. According to the X-ray generator described in [7], the first fixing member and the second fixing member can be fixed to the circuit such that the first fixing member and the second fixing member do not affect the booster.

An X-ray generator according to one aspect of the present disclosure may be [8] “an X-ray generator including: a housing; an electron gun configured to emit an electron beam inside the housing; a target configured to generate an X-ray beam in response to incidence of the electron beam on the target inside the housing; a source configured to generate a voltage to be applied to the electron gun or the target; a feeder configured to feed the voltage to the electron gun or the target; and a fixing member including at least one of a first fixing member that is insulating and a second fixing member that is insulating or conductive, in which the source includes: a container; an insulator that is liquid or gaseous, the insulator being stored in the container; and a circuit being covered with the insulator, the circuit includes: a first voltage section configured to receive a first voltage from outside; a booster configured to boost the first voltage to a second voltage as the voltage; and a second voltage section configured to output the second voltage to the electron gun or the target through the feeder, the first fixing member is covered with the insulator, and is fixed to each of the circuit and the container, and the second fixing member is covered with the insulator, and is fixed to each of the circuit and the feeder”.

According to the X-ray generator described in [8], the fixing member includes at least one of the first fixing member that is insulating and the second fixing member that is insulating or conductive. In a case where the fixing member includes at least the first fixing member, the first fixing member is covered with the insulator and is fixed to each of the circuit and the container. Thus, for example, in use of the X-ray generator, the position of the circuit in the insulator can be kept stable. In addition, in a case where the fixing member includes at least the second fixing member, the second fixing member is covered with the insulator and is fixed to each of the circuit and the feeder. Thus, for example, in use of the X-ray generator, the position of the circuit in the insulator can be kept stable. Therefore, according to the X-ray generator described in [8], the positional displacement of the circuit in the insulator can be prevented.

According to the present disclosure, provided can be the X-ray generator that prevents the positional displacement of the circuit in the insulator.

What is claimed is:

1. An X-ray generator comprising:
a housing;
an electron gun configured to emit an electron beam inside the housing;
a target configured to generate an X-ray beam in response to incidence of the electron beam on the target inside the housing;
a source configured to generate a voltage to be applied to the electron gun or the target;
a feeder configured to feed the voltage to the electron gun or the target; and
a fixing member including at least one of a first fixing member that is insulating and a second fixing member that is insulating or conductive,
wherein the source includes: an insulator that is solid; and a circuit embedded in the insulator,
the circuit includes: a first voltage section configured to receive a first voltage from outside; a booster configured to boost the first voltage to a second voltage as the voltage; and a second voltage section configured to output the second voltage to the electron gun or the target through the feeder,
the first fixing member is embedded in the insulator, is fixed to the circuit, and reaches a surface of the insulator, and
the second fixing member is embedded in the insulator, and is fixed to each of the circuit and the feeder.

2. The X-ray generator according to claim 1, wherein the fixing member includes at least the first fixing member.

3. The X-ray generator according to claim 2, wherein the fixing member includes both the first fixing member and the second fixing member.

4. The X-ray generator according to claim 3, wherein the feeder is embedded in the insulator such that part of the feeder is exposed outward from the insulator.

5. The X-ray generator according to claim 3,
wherein the housing and the feeder are fixed to each other,
the feeder is embedded in the insulator such that entirety of the feeder is located within the insulator, and
the housing is embedded in the insulator such that part of the housing is exposed outward from the insulator.

6. The X-ray generator according to claim 1,
wherein the circuit further includes a substrate on which the first voltage section, the booster, and the second voltage section are mounted, and
at least one of the first fixing member and the second fixing member is fixed to the substrate.

7. The X-ray generator according to claim 1,
wherein the first fixing member is fixed to a side of location of the first voltage section of the circuit with respect to the booster, and
the second fixing member is fixed to a side of location of the second voltage section of the circuit with respect to the booster.

8. An X-ray generator comprising:
a housing;
an electron gun configured to emit an electron beam inside the housing;
a target configured to generate an X-ray beam in response to incidence of the electron beam on the target inside the housing;
a source configured to generate a voltage to be applied to the electron gun or the target;
a feeder configured to feed the voltage to the electron gun or the target; and
a fixing member including at least one of a first fixing member that is insulating and a second fixing member that is insulating or conductive,
wherein the source includes: a container; an insulator that is liquid or gaseous, the insulator being stored in the container; and a circuit being covered with the insulator,
the circuit includes: a first voltage section configured to receive a first voltage from outside; a booster configured to boost the first voltage to a second voltage as the voltage; and a second voltage section configured to output the second voltage to the electron gun or the target through the feeder,
the first fixing member is covered with the insulator, and is fixed to each of the circuit and the container, and
the second fixing member is covered with the insulator, and is fixed to each of the circuit and the feeder.
